(19) United States
(12) Patent Application Publication
(10) Pub. No.: US 2016/0032129 A1
(43) Pub. Date: Feb. 4, 2016

(54) MINERAL FILLED POLYMER COMPOUNDS FOR CURTAIN COATING

(71) Applicant: HERITAGE PLASTICS, INC., Picayune, MS (US)

(72) Inventor: FRANK A. RUIZ, FLOWER MOUND, TX (US)

(21) Appl. No.: 14/814,642

(22) Filed: Jul. 31, 2015

Related U.S. Application Data
(60) Provisional application No. 62/032,916, filed on Aug. 4, 2014.

(51) Int. Cl. C09D 123/06; B05D 1/30

(52) U.S. Cl. CPC C09D 123/06; B05D 1/305; C08K 3/26

(57) ABSTRACT

A mixture used for curtain coating a flexible substrate includes calcium carbonate and low density polyethylene. The calcium carbonate comprises 15%-80% by weight of the mixture and the low density polyethylene comprises 85%-20% by weight of the mixture. The calcium carbonate and the low density polyethylene are combined in a melt compounded blend.

### CROSS-REFERENCE TO RELATED APPLICATIONS

This application claims benefit of U.S. Provisional App. No. 62/032,916, filed on Aug. 4, 2014, entitled MINERAL FILLED POLYMER COMPOUNDS FOR CURTAIN COATING (Atty. Dkt. No HPLA-32308), which is incorporated by reference in its entirety.

### TECHNICAL FIELD

The present invention relates to curtain coating technologies for coating paper, linerboard, film, foil, woven or nonwoven fabrics, or other flexible substrates, and more particularly, to curtain coating technologies using mineral filled polymers.

### BACKGROUND

Paper and other flexible substrates coated with a polymeric material are desirable because the coating is used to increase the strength of the flexible substrate, impart water resistance to the flexible substrate, improved barrier properties of the flexible substrate and provide a heat sealable surface. Low-density polyethylene is used commonly in curtain coating of flexible substrates as it provides all of the advantages mentioned above.

Polyethylene curtain coating is used to impart gaseous and liquid barrier properties and provide a heat sealable surface to paper, linerboard, foil, woven and nonwoven fabrics, and other flexible substrates. Most polyethylene used for curtain coating is produced using a high pressure, free radical process in a stirred autoclave reactor. The raw material, ethylene gas, is raised to a pressure of 25,000 psi and fed into the reactor vessel. Control of specific reaction conditions yields a polymer with the proper molecular weight, molecular weight distribution, and long chain branching structure for use in high speed curtain coating applications.

The importance of these polymer characteristics is more fully detailed in U.S. Pat. Nos. 4,427,833; 5,395,471 and 5,350,476. For optimum performance, the proper melt index, density, molecular weight distribution, branching level, branch length and branching distribution for material produced using the high-pressure tubular process are necessary. Polyethylene produced using a high pressure autoclave-process is preferred over material produced using the high pressure tubular process, as the former yields polymers with proper long chain branching, molecular weight distribution and other characteristics for high-speed extrusion coating. In general, polyethylene produced using the high-pressure tubular process suffers from “neck in.” Neck in is the decrease in the molten web width between the die exit point in the point where the molten polyethylene contacts the substrate. A minimal amount of neck in is desired to maximize the width of the coating on the substrate. Maximizing coating width is important in obtaining full utilization of the capital spent on the coating equipment.

Low-density polyethylene requires the use of fossil fuel resources in its production. Fossil fuel resources of petroleum and natural gas are used as the feedstock for the production of low-density polyethylene. There is an increasing desire to reduce product dependence on fossil fuel resources, and therefore a desire to supplement the polyethylene in the coating with a non-petrochemical derived raw material.

### SUMMARY

The present invention, as disclosed a described herein, in one embodiment, comprises a mixture used for curtain coating a flexible substrate includes calcium carbonate and low density polyethylene. The calcium carbonate comprises 15%-80% by weight of the mixture and the low density polyethylene comprises 85%-20% by weight of the mixture. The calcium carbonate and the low density polyethylene are combined in a melt compounded blend.

### BRIEF DESCRIPTION OF THE DRAWINGS

For a more complete understanding, reference is now made to the following description taken in conjunction with the accompanying Drawings in which:

FIG. 1 illustrates a flow diagram of a process for curtain coating a flexible substrate;

FIG. 2 illustrates a flow diagram describing a curtain coating process in more detail;

FIG. 3 illustrates a flow diagram of a particular curtain coating process; and

FIG. 4 illustrates the components used in a curtain coating process.

### DETAILED DESCRIPTION

Referring now to the drawings, wherein like reference numbers are used herein to designate like elements throughout, the various views and embodiments of a mineral filled polymer compounds for curtain coating a flexible substrate are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

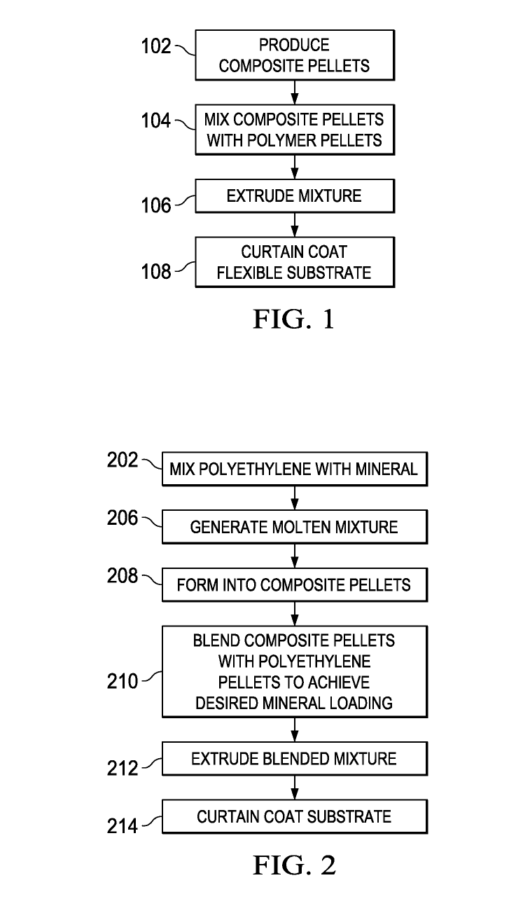

FIG. 1 illustrates a flow diagram describing the general process for curtain coating a flexible substrate using a mineral filled polymer compound. Initially, at step 102, the mineral filled polymer compound composite pellets are created. These pellets will have a known mineral content that can be mixed with other non-mineral filled polymer compounds in order to achieve a desired level of mineral content within the polymer curtain coating layer being placed upon a flexible substrate. The composite pellets comprise a pelletized concentrate comprising 60%-80% calcium carbonate by weight in a low density polyethylene for blending with LDPE pellets to produce a desired mineral loading.

The minerals are utilized to reinforce and reduced the cost of polymers. Mineral additions, such as calcium carbonate, can improve stiffness, impact strength, heat resistance, wear resistance, chemical resistance, and other important and useful characteristics of the base polymer. An added benefit of mineral incorporation within the polymer is reduced costs. This is due to the fact that the mineral is usually much less expensive on a weight basis than the polymer being replaced. This is why a large proportion of higher cost engineering polymers, such as polyimide or polybutylene terephthalate, contain mineral or other inorganic reinforcements. Mineral additions to polymers reduce the energy required for processing, as the minerals improve heat conductivity of the molten compound. This improves the thermal efficiency of heating and cooling conducted during polymer processing.

Minerals often have a lower manufacturing environmental footprint then solely petroleum-based polymers, and mineral additions can affect a significant reduction in the amount of greenhouse gases and other atmospheric pollutants in the end product lifecycle analysis. The manufacture of low-density polyethylene by the high-pressure autoclave process requires reactor pressures of 25,000 psi, which is generated by compressors with over 10,000 HP (7450 kW). The high energy usage results in a greenhouse gas equivalent of approximately 4000 pounds per ton of LDPE manufactured. Fine ground minerals have a manufacturing greenhouse equivalent of 800-1000 pounds per ton. Thus, the significant reduction of greenhouse gases is apparent from the introduction of the mineral filler within the polymer compound.

The addition of calcium carbonate to LDPE improves the adhesion to coated and uncoated paper and other flexible substrates. This adhesion improvement allows for the reduction of the extrusion coating process temperature, avoiding problems with odor, polymer degradation and gel formation on the extruder. The incorporation of high levels of calcium carbonate mineral in to the extrusion coating process does not provide any adverse coating effects. Standard grades of calcium carbonate cannot be run at high loadings due to the generation of lacing, or appearance of volatile's in the molten plastic curtain. Lacing is intolerable and ruins the value of the coating.

The incorporation of calcium carbonate within LDPE further allows the curtain process to operate continuously over a much longer period of time without the appearance of other defects in the web, which may occur rapidly with previously used grades of calcium carbonate. The process prevents the buildup of degraded material inside the coating die and on the exposed surface of the die where the molten polymer exits, commonly known as the die lips. Buildup of material on the surfaces will cause machine direction streaks in the coating called guidelines which ruins the appearance, performance and value of the coating.

When calcium carbonate is used as the mineral filler within the composite pellets, the calcium carbonate is characterized based upon a number of different attributes. These attributes include, but are not limited to, the average particle size; the particle size distribution, or the relative amount of particles by size; the top size, a numeric value assigned to the maximum particle size present in the mineral; the surface area of the particles, typically expressed in m²/gram; and the aspect ratio, a measure of how much the particle shape differs from a sphere. For example, a sphere has an aspect ratio of 1. A cylindrical particle with a length of 20 microns and a diameter of 5 microns has an aspect ratio of 4.0. Other important properties of the calcium carbonate include the moisture level, which must be low to avoid problems of lacing, die buildup and streaking during the coating process.

Particle size, particle size distribution, top size and surface area of the filler are controlled by the specific grinding process and conditions employed during grinding. The grinding may be done in the dry state, or dry grinding, or in a mineral/water slurry, known as wet grinding. Dry grinding offers an economic advantage as the water does not have to be removed from the finished product. Wet grinding allows the removal of contaminants during processing. Dry ground calcium carbonate requires a source of high purity to prevent non-calcium carbonate impurities from adversely affecting coating color or polymer thermal stability at the high temperatures employed in the extrusion coating process.

Current commercial practice is based on the assumption that in general, calcium carbonate minerals with an average particle size equal to or less than 2 microns are required for satisfactory extrusion coating performance. For example in U.S. Pat. No. 8,889,228 the calcium carbonate specified in the extrusion coating process should not exceed 2 microns average particle size.

Current commercial practice does not consider the particle size distribution of the calcium carbonate. The current calcium carbonates in use have an average particle size of 1-2 microns, but have a broad particle size distribution, including the presence of significant quantities of particles less than 0.5 micron. The calcium carbonates described in the preferred embodiment have little or no particles less than 0.5 micron, and few particles in the 0.5-1.0 micron range. Fine particles may agglomerate during calcium carbonate grinding and treating and cannot be broken up during subsequent plastics processing. At the high temperatures of extrusion coating, these agglomerates release entrapped moisture, causing defects in the coating and a shutdown of the coating process.

The surface area of calcium carbonate minerals currently used in extrusion coating applications is in the range of 3-4 m²/gram of mineral. It has been determined that the optimum surface area of calcium carbonate minerals for extrusion coating should be below 3.0 m²/gram. The lower surface area of the preferred calcium carbonate is due to the reduction in the level of fine particles less than 1.0 micron, which by nature have a much higher surface area per unit weight.

The top cut of calcium carbonate minerals currently used in extrusion coating is in the range of 8-10 microns. It has been determined that top cut of the calcium carbonate mineral may be as high as 18 microns for certain coating applications without adverse effects on the coating process.

After the grinding process, the calcium carbonate is treated with a fatty acid, such as stearic acid or behenic acid to render the mineral surface hydrophobic to repel moisture and lipophilic to allow wetting by the polyethylene with which the calcium carbonate is processed. The importance of the proper surface treatment is described in PCT application numbers WO2011/147778 and WO2014/060286, each of which are incorporated herein by reference in their entirety. Both describe the importance of the calcium carbonate surface treatment and describe alternate surface treatment products and technology that have been developed to improve these critical characteristics. The fatty acid surface treatment of the calcium carbonate is conducted using special high-shear mixing equipment designed to uniformly coat each individual mineral particle, while avoiding the generation of agglomerated mineral particles.

Once the composite pellets including the mineral filler have been created at step 102, the composite pellets may be mixed with other non-mineral infused polymer pellets such as LDPE at step 104 in order to create a polymeric material having a desired level of mineral filler loading. The combined material is melted and extruded at step 106 to create the curtain material that is applied to a flexible substrate via a curtain coating process at step 108.

The curtain coating of polyethylene is typically conducted at temperatures between 580° F. and 640° F. (304° C. and 338° C.) so the coating composition is fluid enough to flow through the die at high speeds and wet the flexible substrate onto which it is coated. In addition, the high temperature of the polymer as it exits the die causes the surface of the coating to oxidize when exposed to the air. This improves the adhesion of the coating to the flexible substrate. These high temperatures ordinarily limit the amount of mineral that may be added to the coating.

As levels of the mineral filler are increased, several problems tend to occur. The mineral may release moisture, which causes voids and defects in the molten curtain and solid coating, and will disrupt the coating process. The excess moisture and other volatiles present in the molten material cause the accumulation of degraded materials on the surface of the die where the molten polymer exists. This causes lines and thin spots in the finished coating. These volatiles may condense on other surfaces of the curtain coating equipment, forcing downtime for equipment cleaning. Moisture and other materials present in the mineral compound may cause the breakdown of the polyethylene, causing yellowing or the formation of hard, cross-linked particles which interrupt the coating process and yield a defective coated product. The present embodiment eliminates the problems encountered with the addition of high levels of calcium carbonate (>15 percent) and allows commercial production of curtain coated products containing up to 50 percent calcium carbonate in low-density polyethylene.

These problems are improved upon by using a calcium carbonate mineral of 3-5 microns average particle size with a reduced numbers of particles below 1.0 microns, no particles below 0.5 microns, a mineral surface area of less than 3.0 m2/g, and the subsequent reduced levels of fatty acid that must be treated onto the mineral surface. Reduced fatty acid levels minimize the possibility of yellowing of the polymer or hard particle gel formation. The lack of fine particles results in the elimination of agglomerates and reduces the inherent moisture content of the mineral. The low moisture level allows the use of only low levels of a moisture scavenger such as calcium oxide to avoid any processing problems.

Referring now to FIG. 2, there is provided a more detailed flow diagram of the process for curtain coating a flexible substrate using a mineral filled polymer. Initially, at step 202, polyethylene is mixed with a mineral filler such as calcium carbonate. This process involves a feeding, melting and mixing the polyethylene and mineral filler material into a desired proportion. A molten mixture is generated, at step 206, for the mixed combination of polyethylene and mineral filler, such as calcium carbonate, such that they may be mixed together, cooled and formed into composite pellets at step 208.

Next, at step 210, the composite pellets are blended with polyethylene pellets without filler in order to achieve a desired loading of mineral filler material within a final product mixture. Thus, if a higher level of calcium carbonate mineral filler was desired within a final coating, a higher percentage of composite pellets including calcium carbonate would be added to a lower percentage of polyethylene pellets. Similarly, if a lower level of calcium carbonate mineral filler were desired in a final product, a higher percentage of polyethylene pellets and a lower percentage of composite pellets would be added to the mixture. The final blended mixture at the desired loading levels are melted and extruded, at step 212, to provide the desired coating mixture for the flexible substrate. This coating mixture is curtain coated onto the flexible substrate at step 214.

### Example 1

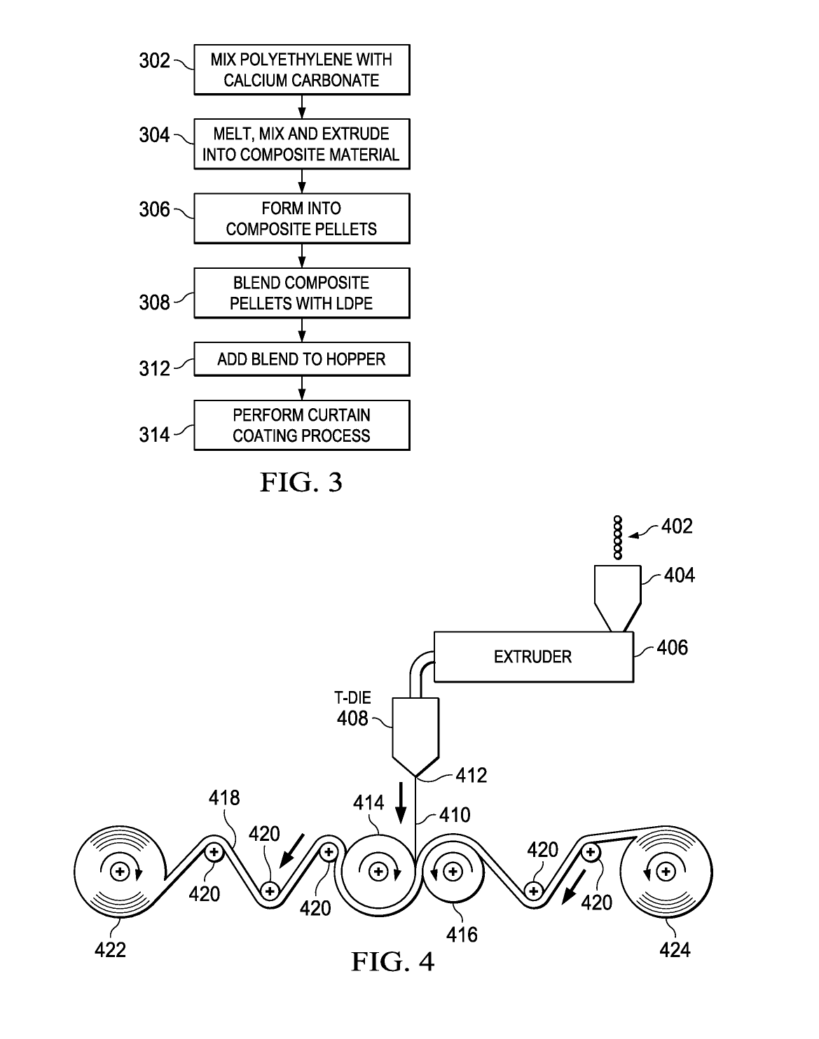

Referring now to the flowchart of FIG. 3, low-density polyethylene with a melt flow of 13 is mixed, at step 302, with 60% calcium carbonate with a medium particle size of 5 microns, a surface area of 2.5 m²/gram, a top size of 18 microns, surface treated with 0.6% stearic acid and 1.5% calcium oxide. The blend is melted, mixed and extruded at step 304 into a molten compound on a continuous mixer and formed into pellets, at step 306, of a mineral/polymer composite, hereinafter referred to as the composite pellets.

The composite pellets are blended, at step 308, with low-density polyethylene pellets (LDPE) of 5.6 MI (melt index) to obtain the desired mineral loading. The composite pellets are blended at step 310 with low-density polyethylene pellets of 5.6 MI to obtain the desired mineral loading for the final coating. The blended pellets are processed on an apparatus as illustrated in FIG. 4. The pellet blend 402 is added, at step 312, to the hopper 404 of a single screw 2.5 inch diameter extruder 406. A curtain coating process is performed using the composite blend 402, at step 314, as more fully described herein below with respect to FIG. 4.

The extruder 406 is fitted with a 24 inch wide T-die 408. The molten composite 410 exits the T-die 408 through a slot 412 at the bottom of the T-die 408 and is cast onto a 24 inch wide, 12 inch diameter chrome plated, polished, cooled chill roll 414. The molten composite 410 is pressed against the chill roll 414 by a nip roll 416. The solidified composite 418 (the coated flexible substrate) is continuously pulled away from the chill roll 414 over several tension control rollers 420 by a winder 422 which maintains tension on the flexible substrate and draws the molten composite 410 down to the desired thickness. The flexible substrate is pulled off of a roller 424. The composite low-density polyethylene pellet blends were processed under the conditions detailed in Table 1.

TABLE 1

| % | Extruder | | | | | | | |
|---|---|---|---|---|---|---|---|---|
| Calcium | Screw | Melt | Chill | Line | | Web | Basis | Coating |
| Calcium | Speed, | Temp | roll | Speed | Output, | Neck-in, | weight, | Thickness, |
| in LDPE | RPM | (F.) | temp (F.) | (fpm) | lb./hr. | inches | lb./ream | mil |
| 0 | 50 | 600 | 67 | 1000 | 160 | 1.30 | 6.1 | 0.4 |
| 12 | 46 | 600 | 67 | 1000 | 160 | 1.35 | 6.3 | 0.4 |
| 24 | 39 | 600 | 67 | 1000 | 160 | 1.50 | 6.1 | 0.4 |
| 36 | 34 | 600 | 67 | 1000 | 160 | 1.90 | 6.5 | 0.4 |
| 48 | 29 | 600 | 67 | 1000 | 160 | 2.05 | 6.1 | 0.4 |

The above combination allows the addition of high levels of calcium carbonate to curtain coated LDPE to significantly improve reduction efficiency, raw material economics and coating performance without adversely affecting the curtain coating process.

### Example 2

In another example, low-density polyethylene with a melt flow of 13 g/dmin is mixed with 75% calcium carbonate with a medium particle size of 3 microns, a top size of 8 microns, a surface area of 2.8 m²/gram and surface treated with 0.8% stearic acid and 1.5% calcium oxide. The blend is melted, mixed and extruded into a molten compound on a Farrel continuous mixer and is extruded in formed into composite pellets of a mineral/polymer concentrate. The composite pellets are blended with additional low-density polyethylene to obtain the desired calcium carbonate loading level and the blend is again processed on the apparatus illustrated in FIG. 4 under the conditions detailed in Table 2.

TABLE 2

| % | Extruder | | | | | | | |
|---|---|---|---|---|---|---|---|---|
| Calcium | Screw | Melt | Chill | Line | | Web | Basis | Coating |
| Calcium | Speed, | Temp | roll | Speed | Output, | Neck-in, | weight, | Thickness, |
| in LDPE | RPM | (F.) | temp (F.) | (fpm) | lb./hr. | inches | lb./ream | mil |
| 0 | 52 | 600 | 63 | 1200 | 160 | 1.25 | 3.95 | 0.28 |
| 30 | 39 | 612 | 63 | 1200 | 160 | 1.85 | 4.02 | 0.29 |
| 34 | 38 | 611 | 63 | 1200 | 160 | 1.87 | 4.10 | 0.29 |
| 38 | 36 | 612 | 63 | 1200 | 160 | 2.00 | 4.20 | 0.29 |
| 45 | 34 | 610 | 63 | 1200 | 160 | 2.05 | 4.05 | 0.29 |

The ability to allow operation of the curtain coating process at high speed is a critical factor in the selection of any raw material. The low-density polyethylene used for the majority of curtain coating applications is produced using a high pressure, free radical autoclave process. Operation of a polyethylene autoclave reactor under specific conditions of feed rate, pressure and temperature profiles, stirer rotation and other proprietary factors yield a polymer suitable for high speed curtain coating. Other types of polyethylene, such as tubular process high pressure free radical catalyze polyethylene and linear polyethylene's produced under low-pressure using various organometallic catalyst are generally unsuitable as they cannot be run at the high speech generally encountered in commercial curtain coating operations.

An additive developed for use in the curtain coating process cannot hinder the operation at high speeds. Limitations in the line speed that may be achieved include a resonance in the curtain which causes an oscillation in the thickness of the coating over time (draw resonance), curtain tear off due to the inability of the polymer or composite to draw down to produce a thin coating or inclusions in the molten curtain which cause it to tear during drawdown, causing a shutdown of the process.

Curtain “neck in” is an important consideration during the high speed operation of a curtain coating process. Neck in is the difference between the die opening where the molten polymer exits and the width of the finish coating on the substrate. Minimal neck in is desired to utilize as great a width of the die as possible to maximize efficient utilization of equipment and most economical operation. Undesirable levels of neck in are another major factor that limit the use of high pressure tubular process low-density polyethylene and low-pressure process linear polyethylene's in curtain coating applications.

As shown in Table 3, addition of the calcium carbonate concentrate in example 2 does not affect the ability to run at high speeds and has only a minimal effect on neck in of the curtain at the loadings shown.

TABLE 3

| | |
|---|---|
| % | Line Speed |
| calcium | feet/minute |

| carbonate | 300 | 500 | 700 | 1000 | 1200 | 1425 |
|---|---|---|---|---|---|---|
| 0.0% | 1.65 | 1.40 | 1.30 | 1.20 | 1.20 | 1.15 |
| 30.0% | 2.40 | 2.10 | 2.05 | 1.95 | 1.85 | 1.80 |
| 33.8% | 2.42 | 2.15 | 2.03 | 1.92 | 1.87 | 1.80 |
| 37.5% | 2.60 | 2.35 | 2.17 | 2.05 | 2.00 | 1.95 |
| 45.0% | 2.65 | 2.40 | 2.25 | 2.10 | 2.05 | 2.00 |

Adhesion of the coating to the substrate is critical to the performance of the curtain coated product. A loss of adhesion will result in seal failure, leakage or loss of barrier properties of the coated substrate. Calcium carbonate addition has not shown any loss of adhesion to the substrate as shown in Table 4. At higher line speeds calcium carbonate yields improvement in adhesion to the craft paper substrate.

TABLE 4

| | |
|---|---|
| % | |
| calcium | Adhesion to Substrate |

| carbonate | 300 | 500 | 700 | 1000 | 1200 | 1425 |
|---|---|---|---|---|---|---|
| 0.0% | Good | Good | Good | Good | Poor | Poor |
| 30.0% | Good | Good | Good | Good | Fair | Poor |
| 33.8% | Good | Good | Good | Good | Poor | Poor |
| 37.5% | Good | Good | Good | Fair | Poor | Poor |
| 45.0% | Good | Good | Good | Good | Fair | Fair |

Thus, using the above identified mineral filled polymer compounds for curtain coating a flexible substrate improved characteristics of the finished curtain coated substrate may be achieved.

It will be appreciated by those skilled in the art having the benefit of this disclosure that a mineral filled polymer compounds for curtain coating a flexible structure provides an improved manner for producing a curtain coated flexible substrate. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A mixture comprising:
15%-80% by weight of calcium carbonate;
85%-20% by weight of low density polyethylene; and
wherein calcium carbonate and the low density polyethylene are combined in a melt compounded blend.

2. The mixture of claim 1, wherein the low density polyethylene further comprises low density polyethylene produced through a high-pressure free radical autoclave process.

3. The mixture of claim 1, wherein the low density polyethylene has a melt index in a range of 2.0 to 50.0.

4. The mixture of claim 1, wherein the calcium carbonate has a surface area of 1-3 m²/gram, an average particle size of 3.0 to 7.0 microns and a top size of 8.0 to 20.0 microns.

5. The mixture of claim 1 further comprising a fatty acid coating on the surface of the calcium carbonate to render the surface of the calcium carbonate hydrophobic.

6. The mixture of claim 1, wherein the mixture of calcium carbonate and low density polyethylene is in the form of pellets.

7. The mixture of claim 1, wherein the mixture comprises a coating on a flexible substrate.

8. The mixture of claim 1, further including a moisture scavenging agent.

9. The mixture of claim 8, wherein the moisture scavenging agent comprises 1%-4% by weight.

10. The mixture of claim 9, further including an antioxidant stabilizer comprising 0.05%-0.3% by weight.

11. An apparatus comprising:
a flexible substrate;
a curtain coating mixture applied to a surface of the flexible substrate via a curtain coating process, the curtain coating mixture comprising:
15%-80% by weight of calcium carbonate;
85%-20% by weight of low density polyethylene; and
wherein calcium carbonate and the low density polyethylene are combined in a melt compounded blend.

12. The apparatus of claim 11, wherein the low density polyethylene further comprises low density polyethylene produced through a high-pressure free radical autoclave process.

13. The apparatus of claim 11, wherein the low density polyethylene has a melt index in a range of 2.0 to 50.0.

14. The apparatus of claim 11, wherein the calcium carbonate has a surface area of 1-3 m²/gram, an average particle size of 3.0 to 7.0 microns and a top size of 8.0 to 20.0 microns.

15. The apparatus of claim 11, wherein the curtain coating mixture further includes a fatty acid coating on the surface of the calcium carbonate to render the surface of the calcium carbonate hydrophobic.

16. The apparatus of claim 11, wherein the curtain coating mixture further includes a moisture scavenging agent.

17. The apparatus of claim 16, wherein the moisture scavenging agent comprises 1%-4% by weight.

18. The apparatus of claim 17, further including an antioxidant stabilizer comprising 0.05%-0.3% by weight.

19. The apparatus of claim 11, wherein the flexible substrate is selected from the group consisting essentially of paper, foil, woven fabric, non-woven fabric or other flexible material.

20. A method for producing a curtain coated flexible substrate comprising:
generating a melt compounded blend including a mixture of 15%-80% by weight of calcium carbonate and 85%-20% by weight of low density polyethylene;
generating a composite mixture of the melt compounded blend and a low density polyethylene compounded having a predetermined load level of calcium carbonate; and
curtain coating the flexible substrate using the composite mixture.

21. The method of claim 20, wherein the low density polyethylene has a melt index in a range of 2.0 to 50.0.

22. The method of claim 20, wherein the calcium carbonate has a surface area of 1-3 m²/gram, an average particle size of 3.0 to 7.0 microns and a top size of 8.0 to 20.0 microns.

23. The method of claim 20, wherein the step of generating the melt compounded blend further comprises applying a fatty acid coating on the surface of the calcium carbonate to render the surface of the calcium carbonate hydrophobic.

24. The method of claim 20, wherein the step of generating the composite mixture further comprises extruding the composite mixture of calcium carbonate and low density polyethylene into pellets.

25. The method of claim 20, wherein the step of generating the melt compounded blend further comprises forming the melt compounded blend into pellets.

26. The method of claim 20, wherein the step of generating the melt compounded blend further comprises applying a moisture scavenging agent to the melt compounded blend.

27. The method of claim 26, wherein the step of applying the moisture scavenging agent further comprises applying a moisture scavenging agent comprising 1%-4% by weight of the melt compounded blend.

28. The method of claim 27, wherein the step of generating the melt compounded blend further comprises applying an antioxidant stabilizer comprising 0.05%43% by weight of the melt compounded blend to the melt compounded blend.
